(19) United States
(12) Patent Application Publication
(10) Pub. No.: US 2026/0347543 A1
(43) Pub. Date: Nov. 5, 2026

(54) INFARED PLASTIC OPTICS FROM CHALCOGENIDE HYBRID INORGANIC/ORGANIC POLYMERS

(71) Applicant: Arizona Board of Regents on Behalf of the University of Arizona, Tucson, AZ (US)

(72) Inventors: Dong Chul Pyun, Tucson, AZ (US); Robert Norwood, Tucson, AZ (US); Abhinav Nishant, Tucson, AZ (US); Tristan Kleine, Tucson, AZ (US); Nicholas Lyons, Tucson, AZ (US); Kyungjo Kim, Tucson, AZ (US)

(73) Assignee: Arizona Board of Regents on Behalf of the University of Arizona, Tucson, AZ (US)

(21) Appl. No.: 19/123,349

(22) PCT Filed: Nov. 2, 2023
(86) PCT No.: PCT/US2023/036707

§ 371 Date: Apr. 22, 2025

Related U.S. Application Data
(60) Provisional application No. 63/422,548, filed on Nov. 4, 2022.

(51) Int. Cl. C08G 75/16; G02B 1/04

(52) U.S. Cl. CPC C08G 75/16; G02B 1/041

(57) ABSTRACT

An article of manufacture includes a reaction product of a mixture of elemental sulfur and a comonomer selected from one or more of vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers, wherein the article of manufacture is suitable for use in flat imaging optics or micro-optics.

### CROSS REFERENCE TO RELATED APPLICATIONS

This application claims the benefit of priority to U.S. Provisional Patent Application No. 63/422,548 filed Nov. 4, 2022, which is incorporated herein by reference, in its entirety for any and all purposes.

### FIELD

The present invention relates to articles of manufacture suitable for use in flat imaging optics or micro-optics.

### BACKGROUND

High-resolution thermal imaging in near or complete darkness relies on optical technologies in the mid-wave (3-5 μm, MWIR) or long-wave (7-14 μm, LWIR) infrared spectrum. In simple terms, infrared imaging is based on the physics of black-body radiation, where an object at an equilibrium temperature radiates photons of a given wavelength that directly correlates to that temperature. Human beings maintain equilibrium temperatures around 37 °C/310 K, and hence emit low-energy photons in the IR spectral range, from 3-14 μm. As humans constantly radiate IR photons, IR imaging and sensing are emerging technologies used for tracking human behavior, crowd monitoring, the internet of things and transportation safety measures (e.g., automobiles and self-driving vehicles). While IR thermal imaging has been widely deployed for military applications, there is also strong interest to apply it to consumer products for smartphones, portable electronics, transportation, and other emerging markets. A major concern is that IR imaging systems are generally more expensive than those operating at visible wavelengths, which currently limits the widespread use of IR cameras for nondefense related markets, where camera costs remain prohibitive for high-volume deployment.

Long wavelength infrared (LWIR) imaging is a technologically important area in optics for a wide range of applications in defense, environmental science, astronomy, agriculture and consumer electronics. For LWIR optics, expensive, low earth abundant inorganic materials, such as germanium or chalcogenide materials (e.g., ZnSe, chalcogenide glasses-ChG's) have been the only materials option to date due to the paucity of substances that are transparent in the LWIR spectrum. However, the high cost of the raw materials and fabrication processes to produce LWIR optical components further raises the price of LWIR cameras; as LWIR detectors have become lower cost due to the advent of microbolometer arrays, it is the optical windows and lenses that have become the cost-limiting factor. Furthermore, since Ge has been identified as a critical element in the United States Geological Survey Mineral Commodities Summary (2019) with the majority of reserves being dominated by China, the development of alternative LWIR materials is a major national security concern due to the US military dependence on IR Ge optics.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY

The desirable IR optical properties found in Ge and amorphous ChG semiconductors arise from the nature of their constituent atoms and bonds. Specifically, the large mass of their atoms shifts the vibrational energies of their bonds to outside the MWIR and LWIR spectral windows. Refractive indices (RI's) for these materials are also typically very high (n>2.0-4.0), again due to the presence of large, highly polarizable atoms. The use of conventional polymeric materials for IR optics would at first sight be precluded by the presence of a high fraction of covalent carbon bonds (e.g., C—C, C—H or C-heteroatom), leading to stretching and bending vibrations in the MW and LWIR regions. This intrinsic limitation is illustrated by the FTIR spectra of polystyrene, where absorptions in the MWIR and LWIR regions are observed with those in the MWIR dominated by C—H stretching vibrations around 3000 cm-1 (~3.3 μm). Hence, the guiding principle in the design of MWIR transparent plastics is the omission of C—H moieties in the material without sacrificing other desirable material properties. However, approaches for LWIR transparency are profoundly more complex due to the abundance of vibrational absorptions in this spectral window for organic-based materials, which is known as the “IR Fingerprint Region” (e.g., 1200 to 700 cm-1). Despite these significant challenges, the advantages of polymeric materials for this application, as previously discussed, call for fundamental research into the synthesis and characterization of LWIR transmissive polymers. Furthermore, the chemical diversity available to organic compounds points to the potential to design polymeric materials that enable LWIR thermal imaging by reducing/eliminating vibrations in the technologically relevant 8-12 μm LWIR spectral window. Another limitation of conventional organic polymers is the low refractive index of these materials (n~1.5-1.65), which calls for much thicker optical elements and larger volumetric footprints that represent problematic aspects for IR cameras. Thus, in addition to improved LWIR transparency, higher RI polymers (n≥1.8) are desirable to enable viable LWIR plastic optics.

Provided in one aspect are articles of manufacture (e.g., optical materials) that are suitable for use in LWIR plastic optics (e.g., flat imaging optics or micro-optics). Flat imaging optics generally include a combination of transmissive thin refractive and diffractive elements, where thin refractive elements achieve imaging through the curvature of a surface (a simple lens) while diffractive elements achieve imaging through the control of the optical phase by using periodic or quasiperiodic structures essentially confined to a plane. The structures generally have periodicities on the order of some integer multiple of the optical wavelength of interest and thicknesses that are inversely proportional to the refractive index, n, i.e., the higher the refractive index the thinner the structure. An example of such a flat imaging optic is a Fresnel lens which has a central refractive region surrounded by increasingly diffractive zones whose period decreases as the diameter of the optics increases. Micro-optics consist essentially of miniature versions of conventional bulk optics; for example, a typical micro-optic lens has a diameter of a few hundred microns, a thickness in the tens of microns, and is deposited onto a suitable transparent substrate. Micro-optics are often produced in an array format, where identical micro-lenses are positioned in a periodic array, with the periodicity being determined by the application. These articles of manufacture include a reaction product of a mixture of elemental sulfur and a comonomer selected from one or more of vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers. The articles of manufacture described herein have LWIR transparency and a high refractive index (n>1.7).

In some embodiments, the elemental sulfur is S₈. In some embodiments, the comonomer is or comprises a norbornene dimer. In some embodiments, the comonomer is or comprises 1,3-diisopropenylbenzene.

In some embodiments, the reaction product has a refractive index of from about 1.7 to about 2.2. In some embodiments, the reaction product has a glass transition temperature of from about 75 °C to about 100 °C. In some embodiments, the reaction product has a glass transition temperature of about 100 °C.

In some embodiments, the article is substantially transparent in a spectrum having a wavelength range of about 1 micron to about 14 microns. In some embodiments, the article is substantially transparent in a spectrum having a wavelength range of about 7 microns to about 14 microns, about 3 microns to about 5 microns, about 700 nm to about 1650 nm, or about 1310 nm to about 3000 nm. In some embodiments, the article is substantially transparent in a spectrum having a wavelength range of about 3 microns to about 5 microns. In some embodiments, the article is substantially transparent in a spectrum having a wavelength range of about 1 microns to about 4 microns. In some embodiments, the reaction product is coated and cured as a thin film on a substrate. In some embodiments, the reaction product is shaped and cured using a mold. In some embodiments, the article is a Fresnel lens. In some embodiments, the article is a microlens array. In some embodiments, the article has a pattern that is modulated with spatial periodicity and has a feature size of from about 0.1 micron to about 100 microns or from about 0.1 mm to about 1 mm. In some embodiments, the article has a size and a dimension that are controlled by photolithographic methods to create masters having features with dimensions of about 10 nm to about 1000 microns with respect to lens height and width.

Also provided in another aspect is an imaging device comprising any one of the articles of manufacture described herein. In some embodiments, the imaging device is a long-wave infrared imaging device. In some embodiments, the imaging device is a long-wave infrared thermal imaging device. In some embodiments, the imaging device is a long-wave infrared thermal imaging device suitable for a temperature range of from about 40 °C to about 200 °C.

### BRIEF DESCRIPTION OF THE DRAWINGS

FIG. 1 is an illustration of a LWIR imaging system, according to some embodiments.

FIG. 2 is an illustration of the US Air Force Target (USAF Target) and The University of Arizona Infrared Target (UA-IRT).

FIG. 3 shows the LWIR imaging results with PMMA sheet IR photon mask with UArizona “A” Logo and “CHIPS” using free standing poly(S-r-NBD2) Fresnel lens, collected at 40-200 °C.

FIG. 4 shows the side-by-side LWIR imaging with a free standing poly(S-r-NBD2) Fresnel lens (top) having a lens thickness of about 0.7-1 mm and compared to a thin film poly(S-r-NBD2) Fresnel lens (bottom) cast onto NaCl plate (thickness<0.4 mm), collected at 60-200 °C.

FIG. 5 illustrates the fabrication of microlens arrays of poly(S-r-NBD2) using first a microlens array master made via photolithography with a range of lens dimensions (height=0.5 to 100 microns; diameter=0.1 to 1000 microns), followed by replication into a PDMS mold, casting of poly(S-r-NBD2) into this mold and release.

FIG. 6 shows the LWIR imaging of a PMMA sheet IR photomask with UArizona “A” Logo and “CHIPS” using a free-standing poly(S-r-NBD2) microlens array, collected at 40-200 °C The bottom row is from 80 to 200 °C with the best image at 200 °C (lower right).

FIG. 7 is an illustration of a MLA fabrication and setup, according to some embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be constructed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “amine monomer” is a monomer having at least one amine functional group. The amine monomer may be polymerizable through its amine functional group. In one embodiment, aromatic amines and multi-functional amines may be used. Amine monomers include, but are not limited to, m-phenylenediamine, and p-phenylenediamine. The various types of phenylenediamines are inexpensive reagents due to their wide-spread use in the preparation of many conventional polymers, e.g., polyurethanes, polyamides. In the reaction of 1,3-phenylenediamine with S₈ a surprising substitution of the aromatic ring with sulfur groups occurs in the copolymerization.

Furthermore, the resulting sulfur copolymer carried reactive amine moieties that were further reacted with co-monomers, such as, isocyanates, acid chlorides, epoxides, carboxylic acids, esters, amides, alkyl halides, or acrylates to either modify the sulfur copolymer, or make new copolymeric materials, such as, polyamides, polyurethanes, polyamides, and polyethers.

As used herein, the term “thiol monomer” is a monomer having at least one thiol functional group. The thiol monomer may be polymerizable through its thiol functional group. Thiol monomers include, but are not limited to, 4,4′-thiobisbenzenethiol and the like. The term “sulfide monomers” are those that have at least one sulfide functional group. The sulfide monomers may be polymerizable through its sulfide functional group.

As used herein, an alkynyl unsaturated monomer is a monomer having at least one alkynyl unsaturated functional group. The alkynyl unsaturated monomer may be polymerizable through its alkynyl unsaturation (i.e., its triple bond). The term “alkynyl unsaturated monomer” does not include compounds in which the alkynyl unsaturation is part of a long chain alkyl moiety (e.g., unsaturated fatty acids, or carboxylic salts, or esters such as oleates, and unsaturated plant oils). In one embodiment, aromatic alkynes, both internal and terminal alkynes, and multi-functional alkynes may be used. Examples of alkynyl unsaturated monomers include, but are not limited to, ethynylbenzene, 1-phenylpropyne, 1,2-diphenylethyne, 1,4-diethynylbenzene, 1,4-bis(phenylethynyl)benzene, and 1,4-diphenylbuta-1,3-diyne.

As used herein, the term “nitrone monomer” is a monomer having at least one nitrone functional group. The nitrone monomer may be polymerizable through its nitrone functional group. In one embodiment, nitrones, dinitrones, and multi-nitrones may be used. Examples include, but are not limited to, N-benzylidene-2-methylpropan-2-amine oxide.

As used herein, the term “aldehyde monomer” is a monomer having at least one aldehyde functional group. The aldehyde monomer may be polymerizable through its aldehyde functional group. In one embodiment, aldehydes, dialdehydes, and multi-aldehydes may be used.

As used herein, a “ketone monomer” is a monomer with at least one ketone functional group. The ketone monomer may be polymerizable through its ketone functional group. In one embodiment, ketones, diketones, or multi-ketones may be used.

As used herein, the term “epoxide monomer” is a monomer having at least one epoxide functional group. The epoxide monomer may be polymerizable through its epoxide functional group. Non-limiting examples of such monomers include, generally, mono- or polyoxiranylbenzenes, mono- or polyglycidylbenzenes, mono- or polyglycidyloxybenzenes, mono- or polyoxiranyl(hetero)aromatic compounds, mono- or polyglycidyl(hetero)aromatic compounds, mono- or polyglycidyloxy (hetero)aromatic compounds, diglycidyl bisphenol A ethers, mono- or polyglycidyl(cyclo)alkyl ethers, mono- or polyepoxy(cyclo)alkane compounds and oxirane-terminated oligomers. In one preferred embodiment, the epoxide monomers may be benzyl glycidyl ether and tris(4-hydroxyphenyl) methane triglycidyl ether. In certain embodiments, the epoxide monomers may include a (hetero)aromatic moiety such as, for example, a phenyl, a pyridine, a triazine, a pyrene, a naphthalene, or a polycyclic (hetero)aromatic ring system, bearing one or more epoxide groups. For example, in certain embodiments, the one or more epoxide monomers are selected from epoxy (hetero)aromatic compounds, such as styrene oxide and stilbene oxide and (hetero)aromatic glycidyl compounds, such as glycidyl phenyl ethers (e.g., resorcinol diglycidyl ether, glycidyl 2-methylphenyl ether), glycidylbenzenes (e.g., (2,3-epoxypropyl)benzene) and glycidyl heteroaromatic compounds (e.g., N-(2,3-epoxypropyl) phthalimide). In certain desirable embodiments, an epoxide monomer will have a boiling point greater than 180 °C, greater than 200 °C, or even greater than 230 °C at the pressure at which polymerization is performed (e.g., at standard pressure, or at other pressures).

As used herein, the term “thiirane monomer” is a monomer having at least one thiirane functional group. The thiirane monomer may be polymerizable through its thiirane functional group. Non-limiting examples of thiirane monomers include, generally, mono- or polythiiranylbenzenes, mono- or polythiiranylmethylbenzenes, mono- or polythiiranyl(hetero)aromatic compounds, mono- or polythiiranylmethyl(hetero)aromatic compounds, dithiiranylmethyl bisphenol A ethers, mono- or polydithiiranyl(cyclo)alkyl ethers, mono- or polyepisulfide (cyclo)alkane compounds, and thiirane-terminated oligomers. In some embodiments, thiirane monomers may include a (hetero)aromatic moiety such as, for example, a phenyl, a pyridine, a triazine, a pyrene, a naphthalene, or a poly cyclic (hetero)aromatic ring system, bearing one or more thiirane groups. In certain desirable embodiments, a thiirane monomer will have a boiling point greater than 180 °C, greater than 200 °C, or even greater than 230 °C at the pressure at which polymerization is performed (e.g., at standard pressure).

As used herein, an ethylenically unsaturated monomer is a monomer having at least one ethylenically unsaturated functional group. The ethylenically unsaturated monomer may be polymerizable through its ethylenic unsaturation (i.e., its double bond). The term “ethylenically unsaturated monomer” does not include compounds in which the ethylenic unsaturation is part of a long chain alkyl moiety (e.g., unsaturated fatty acids such as oleates, and unsaturated plant oils).

In certain embodiments, the one or more ethylenically unsaturated monomers are vinyl monomers, (meth)acryl monomers, unsaturated hydrocarbon monomers, ethylenically-terminated oligomers, monocyclic and bicyclic olefins. In some embodiments, the ethylenically unsaturated monomers include hydroxyl groups or carboxylic acid groups. Examples of such monomers include, generally, mono- or polyvinylbenzenes, mono- or polyisopropenylbenzenes, mono- or polyvinyl(hetero)aromatic compounds, mono- or polyisopropenyl(hetero)aromatic compounds, alkylene di(meth)acrylates, bisphenol A di(meth)acrylates, benzyl (meth)acrylates, phenyl(meth)acrylates, heteroaryl(meth)acrylates, terpenes (e.g., squalene), or carotene. As molten sulfur is non-polar in character, in certain desirable embodiments the one or more ethylenically unsaturated monomers are non-polar. For example, in certain embodiments, the one or more ethylenically unsaturated monomers include a (hetero)aromatic moiety such as, for example, phenyl, pyridine, triazine, pyrene, naphthalene, or a polycyclic (hetero)aromatic ring system, bearing one or more vinylic, acrylic, or methacrylic substituents. Examples of such monomers include benzyl (meth)acrylates, phenyl(meth)acrylates, divinylbenzenes (e.g., 1,3-divinylbenzene, 1,4-divinylbenzene), isopropenylbenzene, styrenics (e.g., styrene, 4-methylstyrene, 4-chlorostyrene, 2,6-dichlorostyrene, 4-vinylbenzyl chloride), diisopropenylbenzenes (e.g., 1,3-diisopropenylbenzene), vinylpyridines (e.g., 2-vinylpyridine, 4-vinylpyridine), 2,4,6-tris((4-vinylbenzyl)thio)-1,3,5-triazine and divinylpyridines (e.g., 2,5-divinylpyridine). Examples of monocyclic olefins include, but are not limited to, cyclopropene, cyclobutene, cyclopentene, cyclohexene, cycloheptene, cyclooctene, cyclononene, cyclodecene, cycloundecene, cyclododecene and the like, Examples of bicyclic olefins, include but are not limited to bicyclo[2.2.1]heptene, norbornene, norbornadiene, cyclo[3.3.0]octene, octahydropentelene, decahydronaphthelene, bicyclo[2.2.2]octene, and the like and derivatives thereof. Compatible cyclic olefins also include strained olefins, dienes, trienes, and tetraenes. In certain embodiments, the one or more ethylenically unsaturated monomers (e.g., including an aromatic moiety) bears an amino (i.e., primary or secondary) group, a phosphine group or a thiol group. One example of such a monomer is vinyldiphenylphosphine. While not intending to be bound by theory, the inventors surmise that the amino or thiol group will undergo a ring-opening nucleophilic attack on an S₈ ring, thus incorporating a short sulfide chain that promotes solubility in molten sulfur. Other ethylenically unsaturated monomers may be used for forming the copolymers described herein. In certain desirable embodiments, an ethylenically unsaturated monomer will have a boiling point greater than 180 °C, greater than 200 °C, or even greater than 230 °C at the pressure at which polymerization is performed (e.g., at standard pressure).

As used herein, the terms “those defined above” and “those defined herein” when referring to a variable incorporates by reference the broad definition of the variable as well as any narrow and/or preferred definitions, if any.

Described herein are articles of manufacture (e.g., optical materials) suitable for use in flat imaging optics or micro-optics. Flat imaging optics generally consist of a combination of transmissive thin refractive and diffractive elements, where thin refractive elements achieve imaging through the curvature of a surface (a simple lens) while diffractive elements achieve imaging through the control of the optical phase by using periodic or quasiperiodic structures essentially confined to a plane. The structures generally have periodicities on the order of some integer multiple of the optical wavelength of interest and thicknesses that are inversely proportional to the refractive index, n, i.e., the higher the refractive index the thinner the structure can be. An example of such a flat imaging optics is a Fresnel lens which has a central refractive region surrounded by increasingly diffractive zones whose period decreases with the radial distance from the center of the lens. Micro-optics consist essentially of miniature versions of conventional bulk optics; for example, a typical micro-optic lens has a diameter of a few hundred microns, a thickness in the tens of microns, and is deposited onto a suitable transparent substrate. Micro-optics are often produced in an array format, where identical micro-lenses are positioned in a periodic array, with the periodicity being determined by the application. These articles of manufacture include a reaction product of a mixture of elemental sulfur and a comonomer selected from one or more of vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers. The ability to use said materials in flat imaging optics and micro-optics structures is surprising, since it was not expected that the materials could be readily molded into structures with dimensions approaching the optical wavelength. This capability could not be anticipated from previous work that was directed entirely at bulk optical components such as conventional lenses, windows, and prisms.

Copolymerizing elemental sulfur with organic comonomers via a process termed “inverse vulcanization” affords hybrid polymers of chalcogenide and organic comonomer units. These hybrid polymers are subsequently termed, Chalcogenide Hybrid Inorganic/Organic Polymers (CHIPs). These materials may be used for IR optics, since the S—S bonds in the copolymer are largely IR inactive in the MWIR and LWIR regime enabling a dramatic reduction in organic C—H, C—C, C—X bond content to below 50-wt % of the material, which results in a dramatic reduction of MWIR and LWIR absorbance of these chalcogenide hybrid polymers vs classical synthetic plastics, while also imparting high n to the macromolecule, which provides for thinner optics. While CHIPs have significantly improved IR transparency relative to state of the art optical polymers, the residual organic content in these materials arising from the organic comonomers limits the overall IR transparency relative to inorganic transmissive materials, hindering direct application of CHIPs for IR plastic optics.

In the embodiments described herein, the elemental sulfur may be S₈. The reaction product of a mixture of elemental sulfur and any one of the comonomers described herein is a sulfur copolymer. The sulfur can be provided as elemental sulfur, for example, in powdered form. Under ambient conditions, elemental sulfur primarily exists in an eight-membered ring form (S₈) which melts at temperatures in the range of 120-124 °C and undergoes an equilibrium ring-opening polymerization (ROP) of the S₈ monomer into a linear polysulfane with diradical chain ends.

While S₈ is generally the most stable, most accessible and lowest cost feedstock, many other allotropes of sulfur can be used (such as other cyclic allotropes, derivable by melt-thermal processing of S₈). Any sulfur species that yield diradical or anionic polymerizing species when heated as described herein can be used in practicing the present invention.

The sulfur polymers/copolymers described herein may be prepared by providing elemental sulfur, heating the elemental sulfur to a suitable temperature (e.g., from about 120 to about 230 °C) to form a molten sulfur, and polymerizing one or more comonomers with the molten sulfur to form the sulfur copolymer. In some embodiments, the technique of polymerizing is free radical polymerization, controlled radical polymerization, ring-opening polymerization, ring-opening metathesis polymerization, step-growth polymerization, or chain-growth polymerization.

The sulfur content of the reaction product (e.g., the sulfur copolymer) may be from about 1% to about 99 wt %, including from about 1% to about 95 wt % and from about 5% to about 95 wt %, In some embodiments, the sulfur content of the reaction product (e.g., the sulfur copolymer) may be from about 50% to about 99 wt %.

The comonomers described herein are those that polymerize with the molten sulfur to form the sulfur copolymer. Illustrative comonomers include one or more of vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers. In some embodiments, the comonomer is or comprises a norbornene dimer. In some embodiments, the comonomer is or comprises 1,3-diisopropenylbenzene.

As described in the Examples, exemplary reaction products (e.g., sulfur polymers or copolymers) are poly(sulfur-random-(1,3-diisopropenylbenzene (poly(S-r-DIB)) and poly(sulfur-random-norbornadiene dimer) (poly(S-r-NBD2). Poly(S-r-NBD2) has a higher glass transition (T_{g}~75-110 °C), greater thermal stability and improved LWIR transparency than poly(S-r-DIB). The structures of these polymers are shown below.

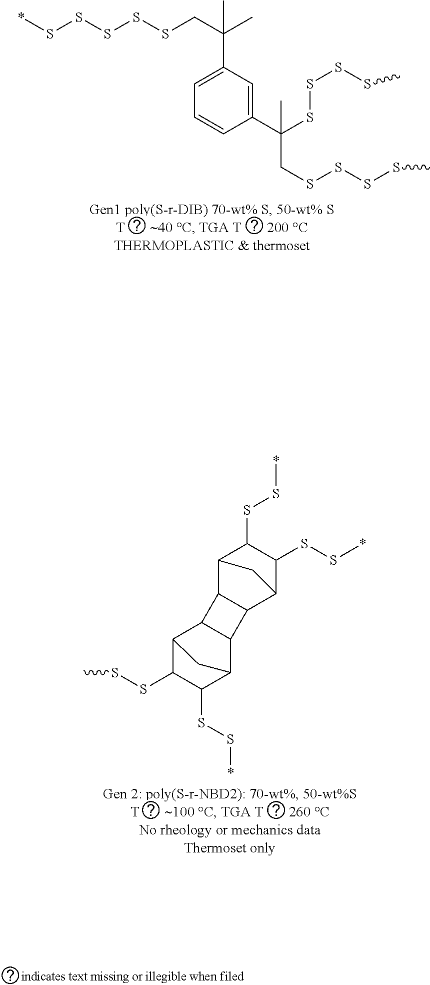

In some embodiments, the reaction product (e.g., sulfur polymer or copolymer) may further include one or more termonomers selected from vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers.

In other embodiments, the reaction product (e.g., sulfur polymer or copolymer) may further include one or more polyfunctional co-monomers such as polyvinyl co-monomers, polyisopropenyl co-monomers, polyacryl co-monomers, polymethacryl co-monomers, polyunsaturated hydrocarbon co-monomers, polyepoxide co-monomers, polythiirane co-monomers, polyalkynyl co-monomers, polydiene co-monomers, polybutadiene co-monomers, polyisoprene co-monomers, polynorbornene co-monomers, polyamine co-monomers, polythiol co-monomers, polysulfide co-monomers, polyalkynylly unsaturated co-monomers, polynitrone co-monomers, polyaldehyde co-monomers, polyketone co-monomers, and polyethylenically unsaturated co-monomers. The polyfunctional co-monomers may be present in an amount ranging from about 0.5 wt % to 1 wt %, or about 1 wt % to 5 wt %, or about 5 wt % to 15 wt %, or about 15 wt % to 25 wt %, or about 25 wt % to 35 wt %, or about 35 wt % to 45 wt %, or about 45 wt % to 50 wt %.

It may be desirable, in some embodiments, to use a nucleophilic viscosity modifier in liquefying the elemental sulfur when preparing the sulfur monomers, for example, before adding the co-monomers. The nucleophilic viscosity modifier can be, for example, a phosphorus nucleophile (e.g., a phosphine), a sulfur nucleophile (e.g., a thiol), or an amine nucleophile (e.g., a primary or secondary amine). When elemental sulfur is heated in the absence of a nucleophilic viscosity modifier, the elemental sulfur rings can open to form sulfur radicals that can combine to form linear polysulfide chains, which can provide a relatively high overall viscosity to the molten material. Nucleophilic viscosity modifiers can break these linear chains into shorter lengths, thereby making shorter polysulfides that lower the overall viscosity of the molten material, making the sulfur monomers easier to mix with other species, and easier to stir for efficient processing. Some of the nucleophilic viscosity modifier will react to be retained as a covalently bound part of the copolymer, and some will react to form separate molecular species, with the relative amounts depending on nucleophile identity and reaction conditions. While some of the nucleophilic viscosity modifier may end up as a separate molecular species from the polymer chain, as used herein, nucleophilic viscosity modifiers may become part of the copolymer. Non-limiting examples of nucleophilic viscosity modifiers include triphenylphosphine, aniline, benzenethiol, and N,N-dimethylaminopyridine. Nucleophilic viscosity modifiers can be used, for example, in an amount up to about 5 wt %, or even up to about 10 wt % of the sulfur copolymer. When a nucleophilic viscosity modifier is used, in certain embodiments it can be used in the range of about 1 wt % to about 10 wt % of the sulfur copolymer.

The copolymerization of the one or more monomers of amine monomers, thiol monomers, sulfide monomers, alkynylly unsaturated monomers, nitrone monomers, aldehyde monomers, and ketone monomers in liquid as used herein may produce these advantageous sulfur copolymer compositions. For example, the amine monomer, such as those on aromatic compounds, results in direct C—S bond formation and copolymerization with sulfur concurrently. Thiol monomers from a wide range of comonomer precursors widely used in the preparation of condensation polymers can be dissolved and copolymerized with liquid sulfur to afford high sulfur content copolymers. Unexpectedly, the thiol derived copolymer was solution processable despite the high content of sulfur and rigid aromatic moieties. Sulfide monomers can copolymerize with sulfur via either ionic or free radical processes. Unexpectedly, the sulfide monomer was able to afford low glass transition polymers and/or higher glass transition polymers. As another example, the alkynylly unsaturated monomer is expected to react via known thiol-yne processes, however, unexpectedly, the alkynylly unsaturated monomer was able to afford polythiophene and other heterocycles. The nitrone monomer is expected to react via free radical polymerizations with sulfur radicals. Unexpectedly, the nitrone monomer was designed to afford polymeric materials when copolymerized with elemental sulfur. Aldehyde based monomers are not expected to react with sulfur radicals, however, the formation of polymers was observed when the appropriate di-, or multifunctional aldehydes are copolymerized with sulfur. Ketone based monomers are not expected to react with sulfur radicals, however, the formation of polymers was observed when the appropriate di-, or multifunctional ketones are copolymerized with sulfur.

The comonomer content of the reaction product (e.g., the sulfur copolymer) may be from about 1% to about 99 wt %, including from about 1% to about 50 wt % and from about 1% to about 30 wt %, In some embodiments, the comonomer content of the reaction product (e.g., the sulfur copolymer) may be from about 1% to about 40 wt %.

The sulfur polymers (e.g., reaction products) described herein have a refractive index of from about 1.5 to about 2.6, including from about 1.5, about 1.6, about 1.7, about 1.8, about 1.9, about 2.0, about 2.1, about 2.2, about 2.3, about 2.4, about 2.5, and about 2.6. In some embodiments, the sulfur polymer (e.g., reaction product) described herein has a refractive index of from about 1.7 to about 2.2, including about 1.7, about 1.8, about 1.9, about 2.0, about 2.1, and about 2.2.

The sulfur polymers (e.g., reaction products) described herein have a glass transition temperature of from about 75 °C to about 100 °C, including about 75 °C, about 80 °C, about 85 °C, about 90 °C, about 95 °C, and about 100 °C. In some embodiments, the sulfur polymer (e.g., reaction product) described herein has a glass transition temperature of about 100 °C.

The articles of manufacture (e.g., Fresnel lens and a microlens array) may be prepared in accordance with the procedures described in the Examples. In some embodiments, the reaction product is coated and cured as a thin film on a substrate. In some embodiments, the reaction product is shaped and cured using a mold. The articles of manufacture described herein are substantially transparent in a spectrum having a wavelength range of about 2 microns to about 20 microns, including about 7 microns to about 14 microns (the long-wave infrared spectrum). In some embodiments, the article is substantially transparent in a spectrum having a wavelength range of about 1 micron to about 14 microns, including about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, and about 14 microns. In some embodiments, the article is substantially transparent in a spectrum having a wavelength range of about 7 microns to about 14 microns, about 3 microns to about 5 microns, about 700 nm to about 1550 nm, or about 1310 nm to about 3000 nm. In some embodiments, the article is substantially transparent in a spectrum having a wavelength range of about 7 microns to about 14 microns, including about 7 microns, about 8 microns, about 9 microns, about 10 microns, about 11 microns, about 12 microns, about 13 microns, and about 14 microns. In some embodiments, the article is substantially transparent in a spectrum having a wavelength range of about 3 microns to about 5 microns, including about 3 microns, about 4 microns, and about 5 microns. In some embodiments, the article is substantially transparent in a spectrum having a wavelength range of about 1 micron to about 4 microns, including about 1 micron, about 2 microns, about 3 microns, and about 4 microns. In some embodiments, the article is substantially transparent in a spectrum having a wavelength range of about 700 nm to about 1550 nm, including about 700 nm, about 800 nm, about 900 nm, about 1000 nm, about 1100 nm, about 1200 nm, about 1300 nm, about 1400 nm, about 1500 nm, and about 1550 nm. In some embodiments, the article is substantially transparent in a spectrum having a wavelength range of about 1310 nm to about 3000 nm, including about 1310 nm, about 1400 nm, about 1500 nm, about 1600 nm, about 1700 nm, about 1800 nm, about 1900 nm, about 2000 nm, about 2100 nm, about 2200 nm, about 2300 nm, about 2400 nm, about 2500 nm, about 2600 nm, about 2700 nm, about 2800 nm, about 2900 nm, and about 3000 nm.

Flat imaging optics generally consist of a combination of transmissive thin refractive and diffractive elements, where thin refractive elements achieve imaging through the curvature of a surface (a simple lens) while diffractive elements achieve imaging through the control of the optical phase by using periodic or quasiperiodic structures essentially confined to a plane. The structures generally have periodicities on the order of some integer multiple of the optical wavelength of interest and thicknesses that are inversely proportional to the refractive index, n, i.e., the higher the refractive index the thinner the structure can be. An example of such a flat imaging optics is a Fresnel lens which has a central refractive region surrounded by increasingly diffractive zones whose period decreases with the radial distance from the center of the lens. Such a Fresnel lens can either be free-standing or deposited on a suitable IR transparent substrate; the detailed structure is optimized for operation in the LWIR, typically near 10 microns optical wavelength. Micro-optics consist essentially of miniature versions of conventional bulk optics; for example, a typical micro-optic lens has a diameter of a few hundred microns, a thickness in the tens of microns and is deposited onto a suitable transparent substrate. Micro-optics are often produced in an array format, where identical micro-lenses are positioned in a periodic array, with the periodicity being determined by the application. In some embodiments, the articles of manufacture may be prepared as a flat imaging optic, which may include a Fresnel lens that can be free standing or substate supported. In some embodiments, the lens design (diffractive pattern) may be modulated to enable IR imaging in the near-IR to the LWIR (1-14 microns).

In some embodiments, the articles of manufacture may be prepared as a thin film suitable for optical use. For instance, the method for making comprises: providing any of the copolymers described herein in a form of a powder; placing the copolymer between two plates; heating the plates and the copolymer to a first temperature; applying a first pressure to the two plates to compress the copolymer for a first allotted time to form a thin film; applying a second pressure to the two plates to compress the thin film for a second allotted time, wherein the second pressure is greater than the first pressure; and cooling the optical thin-film polymer.

In some embodiments, the articles of manufacture may be a lens that is prepared by shaping and curing the reaction product using a mold. For instance, the method for making comprises preparing a lens mold; providing any of the copolymers described herein; pouring the copolymer into the lens mold to form a molded copolymer; curing the molded copolymer to vitrify the molded copolymer to provide a lens; and removing the lens from the lens mold. In some instances, the lens mold may be prepared by mixing an elastomeric base with a curing agent to form a replica mixture; pouring the replica mixture over a master lens to form the lens mold; placing the lens mold under reduced pressure to remove bubbles in the lens mold; curing the lens mold; and removing the lens mold from the master lens.

In some embodiments, the article has a pattern that is modulated with spatial periodicity and has a feature size of from about 0.1 micron to about 100 microns or from about 0.1 mm to about 1 mm. In some embodiments, the article has a size and a dimension that are controlled by photolithographic methods to create masters on the dimensions of about 10 nm to about 1000 microns with respect to lens height and width.

The articles of manufacture described herein are suitable for use in an imaging device, such as a LWIR imaging device. In some embodiments, the imaging device is a long-wave infrared thermal imaging device as shown in the Examples. Even further as demonstrated in the Examples, the imaging device may be a long-wave infrared thermal imaging device suitable for a temperature range of from about 40 °C to about 200 °C, which would allow for thermal imaging at room temperature.

The present invention, thus generally described, will be understood more readily by reference to the following examples, which are provided by way of illustration and are not intended to be limiting of the present invention.

### Examples

The following examples illustrate various protocols for preparing compounds and devices according to the embodiments described above. The examples should in no way be construed as limiting the scope of the present technology.

While certain embodiments have been illustrated and described, it should be understood that changes and modifications can be made therein in accordance with ordinary skill in the art without departing from the technology in its broader aspects as defined in the following claims.

### Example 1. The state of the art for LWIR optical components employed in

LWIR imaging systems in the spectral range of 8-12 μm are fabricated from expensive inorganic transmissive materials such germanium, chalcogenide glasses. The application of synthetic plastics, and CHIPS for LWIR optical components is limited by the reduced LWIR transmittance of these materials at these imaging wavelengths. An optical fabrication approach to mitigate the reduced IR transmittance of synthetic plastics and CHIPS is to design flat imaging optics consisting of surface patterned configuring structures of free-standing materials, or supported films on thin substrates, which generate the desired form of the optical wavefront to enable IR imaging. These flat imaging optics can include metalenses composed of nano, or microstructured thin films arrays on supporting substrates, or classic Fresnel lenses design for the wavelength of interest. Fresnel lenses can either be free standing, or substrate supported enabling thinner lenses to be fabricated onto a transmissive supporting substrate (e.g., NaCl, KBr, Si wafers to some extent); higher refractive index materials can provide for thinner Fresnel lenses for a given imaging application. To date, notable examples of polymer based flat imaging optics for LWIR imaging include photoresist photopatterned multi-level diffractive lenses (~ 10 μm) on Si substrates, and polyethylene-based Fresnel lenses (~80-100 μm) also on Si wafers. Alternatively, micro-optics based on microlens arrays fabricated using photolithography, followed by deposition onto supporting substrates allow for the fabrication of LWIR plastic optics that mitigate the reduced IR transmittance of these materials, particularly for use with arrays of detectors, such as microbolometer arrays.

To date, fabrication using photolithographic methods with CHIPs has been demonstrated with poly(sulfur-random-(1,3-diisopropenylbenzene)) (poly(S-r-DIB)) to prepare polymer waveguides, ring-resonators and splitters for integrated photonics operating at telecommunication wavelengths, but fabrication of micro-optics, or flat imaging optics with CHIPs remains unexplored which we teach and describe in this disclosure.

This example demonstrates the first fabrication of poly(S-r-NBD2) CHIPs using the conventional process flow: CAD design of Fresnel lens, diamond turning of the Fresnel lens into the CHIPs materials, or diamond turning of the Fresnel lens into an acrylic block as a master for molding and casting of the poly(S-r-NBD2) Fresnel lens.

This example demonstrates first fabrication of poly(S-r-NBD2) microlenses using the conventional process flow: CAD design of microlens array, creation of microlens master from photopatterned polymer photoresists, replicas of PDMS made and molding/casting of poly(S-r-NBD2) into PDMS replicas.

This example also outlines the creation of LWIR imaging system using conventional commercially available LWIR microbolometer detectors, paired with CHIPS lenses and development of an LWIR imaging target (termed University of Arizona Infrared Target, UA-IRT).

This example also outlines the successful demonstration for the first time of variable temperature LWIR imaging with CHIPS Fresnel and microlenses.

### Description of LWIR Imaging Components

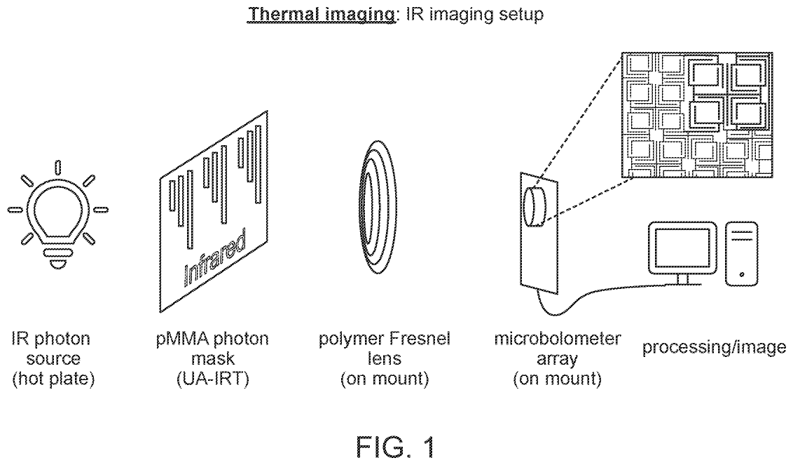

FIG. 1 is an illustration of the LWIR imaging system used for evaluation of CHIPs lenses composed of a commercially available microbolometer from FLIR (FLIR Lepton), fabricated CHIPs lenses, a hotplate as IR source and imaging targets cut from PMMA sheets as an IR photomask.

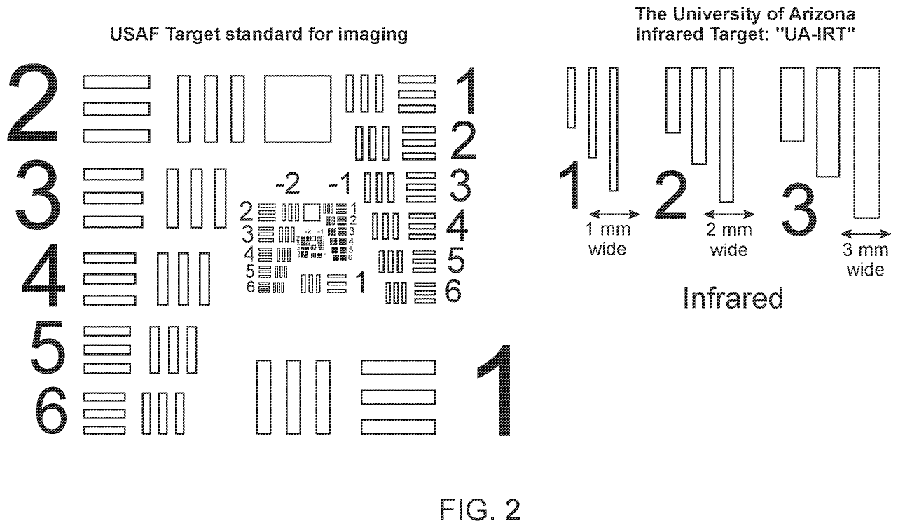

The University of Arizona Infrared Target (UA-IRT) is a macroscopic target with millimeter to centimeter feature sizes for LWIR imaging experiments with fabricated LWIR plastic optics that are designed to possess controllable lengths and widths for standardized LWIR imaging assessment. For most UV-VIS-near IR imaging experiments, very small sub-mm sized features are the standard as implemented on the US Air Force Target (USAF Target), however there is currently no such imaging target for LWIR imaging with fabricated LWIR plastic lenses. The UA-IRT is fabricated from PMMA sheets and using CO₂ lasers with CAD files with UA-IRT dimensions etched into the PMMA sheets and then mated with newly fabricated LWIR plastic lenses and LWIR microbolometer detectors. FIG. 2 illustrates both the US Air Force Target (USAF Target) and The University of Arizona Infrared Target (UA-IRT).

Free standing poly(S-r-NBD2) Fresnel lenses prepared by molding and casting from PDMS replicas of acrylic Fresnel lenses designed with the periodic patterns for LWIR imaging. Process details are provided below and the thickness of these Fresnel lenses was on the order of 1-3 mm.

Thin film poly(S-r-NBD2) Fresnel Lenses cast onto NaCl plates (which are LWIR transmissive) were prepared by molding and casting from PDMS replicas of acrylic Fresnel lenses and then deposited onto NaCl plates to enable much thinner lenses to be cast to improve LWIR imaging quality at lower temperatures.

### Key LWIR Imaging Results

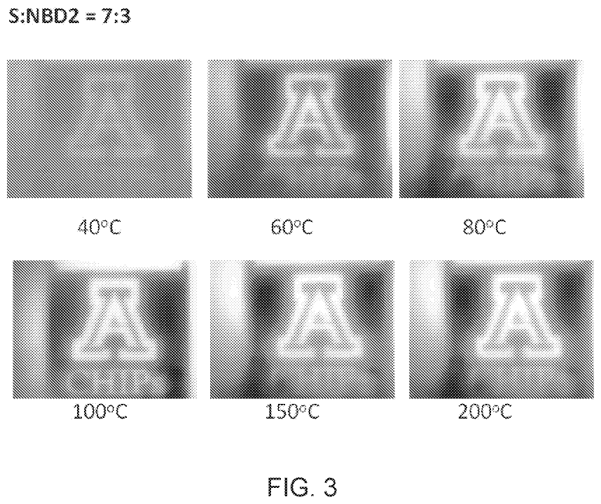

FIG. 3 shows the first LWIR imaging results with PMMA sheet IR photon mask with UArizona “A” Logo and “CHIPS” using free standing poly(S-r-NBD2) Fresnel lens. This series of LWIR images collected at 40-200 °C demonstrates the ability to reach nearly RT LWIR with a CHIPs poly(S-r-NBD2) Fresnel lens.

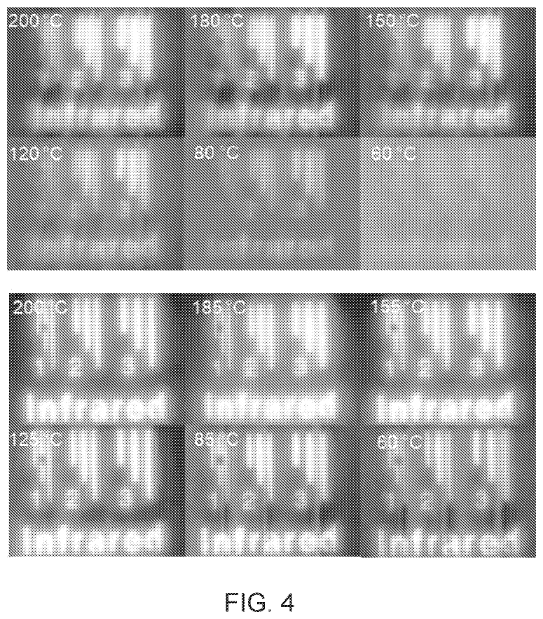

FIG. 4 shows the side-by-side LWIR imaging with a free standing poly(S-r-NBD2) Fresnel lens (TOP) having a lens thickness of about 0.7-1 mm was done and compared to a thin film 70:30 poly(S-r-NBD2) Fresnel lens cast onto NaCl plate (thickness<0.4 mm), which showed much better LWIR imaging at low temperatures. Thinner lenses exhibit less LWIR absorption than thicker free-standing lenses allowing for lower temperature LWIR imaging.

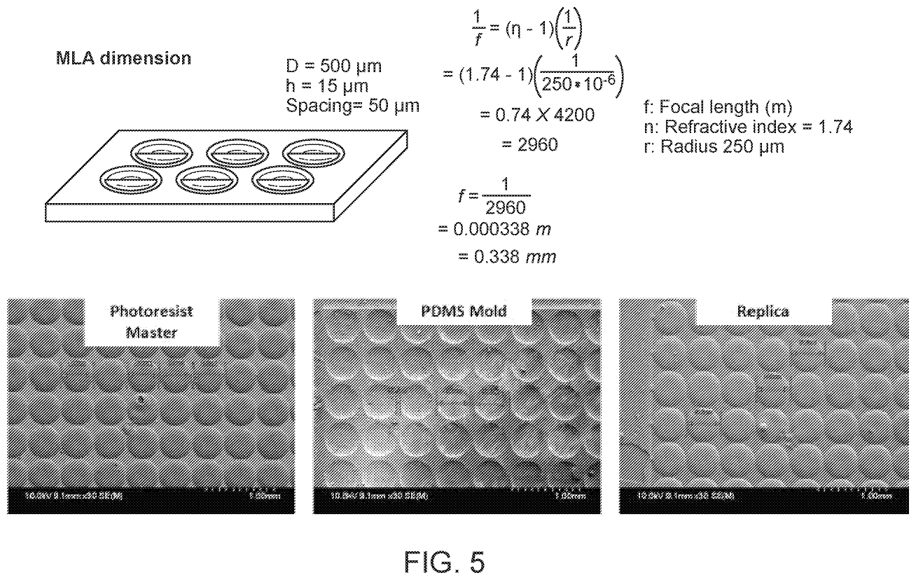

FIG. 5 is an illustration of the successful fabrication of microlens arrays of poly(S-r-NBD2) using first a microlens array master made via photolithography with a range of lens dimensions (height=0.5 to 100 microns; diameter=0.1 to 1000 microns), followed by replication into a PDMS mold, casting of poly(S-r-NBD2) into this mold and release.

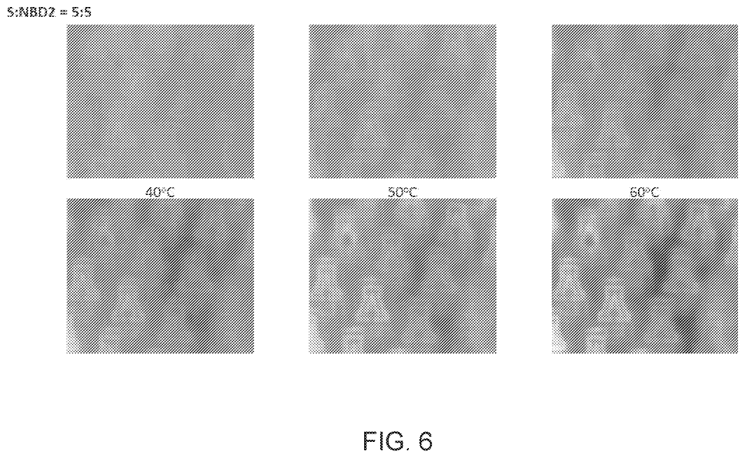

FIG. 6 shows the LWIR imaging with a PMMA sheet IR photomask with UArizona “A” Logo and “CHIPS” using free standing poly(S-r-NBD2) microlens array. This series of LWIR images collected at 40-200 °C demonstrates the ability to reach nearly RT LWIR with a CHIPs poly(S-r-NBD2) microlens array.

### Experimental Details

### A. Synthesis of Norbornadiene dimer (NBD2)

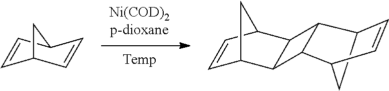

### Scheme 1. Scheme of the NBD2 synthesis from NBD via 2+2 cycloaddition reaction by Ni(COD)₂

Procedure: NBD2 was prepared by following procedure. A flame dried Schlenk flask was equipped with a magnetic stir bar and cooled under a flow of Ar_{(g)}. Ni(COD)₂ (69.6 mg, 0.25 mmol, 0.0025 eq) was added to the flask and repeatedly back-filled 3 times. Norbornadiene and p-dioxane were degassed by Ar_{(g)} bubbling for 15 min separately, and norbornadiene (10 mL, 9.06 g, 1 eq) and 1,4-dioxane (10 mL, 50 v/v %) were added to the flask under Ag_{(g)}. The reaction vessel was then sealed under an argon atmosphere and placed on 60 °C pre-heated oil bath for 6 hours. After 5 hours, the reaction mixture was then cooled to room temperature and diluted with dichloromethane (DCM) then precipitated with methanol while stirring. The resulting heterogeneous mixture was then dried to a tan/brown solid via rotary evaporation. This solid was transferred to a sublimation apparatus and sublimed at 80 °C at 0.15 Torr for 4 hrs with a dry ice/acetone mixture cooling the cold finger, onto which a white crystalline solid was deposited and determined to be the desired product. The cold finger was washed with DCM into a beaker to collect sublimated product, dried with magnesium sulfate anhydride to remove condensed moisture from the atmosphere, then concentrated under reduced pressure to yield a white solid that is dried under vacuum at room temperature. Yield: 4.8 g, 53.0%

### B. Experimental Section for Microlens Fabrication

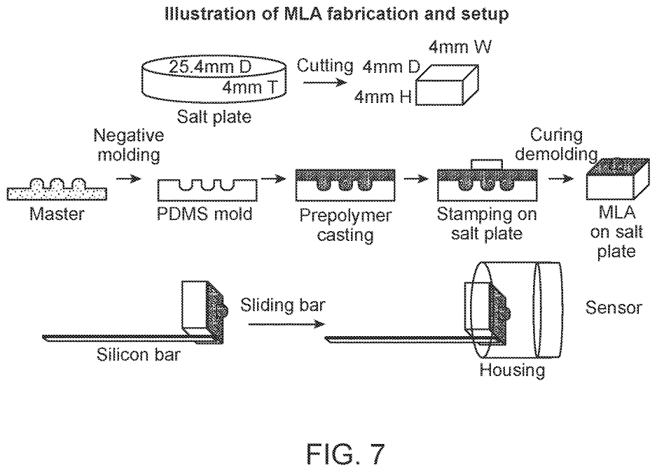

FIG. 7 is an illustration of the MLA fabrication and setup according to some embodiments.

Preparation of polymer photoresist templates: A glass substrate was treated with acetone and isopropanol, followed by O₂ plasma treatment for 3 mins to clean surfaces for polymer photoresist deposition. Polymer photoresist AZ 9260 was spin coated from solution at 1200 rpm, followed by baking at 95 °C for 25 mins to create a 15 micron film. Photopatterning was conducted by exposure using a maskless lithography system (Heidelberg MLA 150; 750 mJ/cm², +10 defocus). Features were developed in AZ400K solution for 2 minutes followed by a postbake treatment at 150 °C for 45 minutes.

Using this methodology, an array with microlenses of different size, geometry and height were fabricated as described below:
pillars with varying radii of 25 microns to 250 microns
5×5 array each of pillars with different radii (25 microns-250 microns)
10×10 array of 15 micron squares with 5 micron spacing
10×10 array of 40 micron squares with 10 micron spacing.

ZnSe substrate supported poly(S-NBD2) microlens arrays: The microlens array master prepared as previously described was replicated in Sylgard 184 PDMS which was cured at room temperature for 16 hours followed by 2 hours at 60 °C As the masters are fabricated on a microscope slide, there is about 1 mm of thickness that will be transferred to the poly(S-NBD2) microlens array as inactive area. To address this, the poly(S-NBD2) microlens arrays can be fabricated on an IR transparent blank with minimal to no flash layer by trimming the PDMS replica such that the walls formed by replicating the glass microscope slide are removed, leaving the actual microlens arrays as the only wells to be filled. This trimmed PDMS replica and a ZnSe blank were placed in a 160 °C oven and allowed to reach thermal equilibrium with the oven. Once this was achieved (45 minutes), elemental sulfur (0.35 g, 70 wt/wt %) and NBD2 (0.15 g, 30 wt/wt %) were added to a vial equipped with a magnetic stir bar, placed in a 165 °C oil bath and then allowed to oligomerize until a noticeable increase in viscosity and color change to dark orange was observed. This prepolymer was then poured into the wells of the PDSM microlens array replica and the ZnSe blank pressed on top of the prepolymer to reduce the thickness of the flash layer. The poly(S-NBD2) was allowed to cure by maintaining 160 °C for 45 minutes and then was removed from the oven with the ZnSe blank. After a brief cooling period (c.a. 5 minutes) the PMDS replica was peeled away from the microlens arrays which remained adhered to the ZnSe blank.

Free standing poly(S-NBD2) microlens arrays: The same procedure outlined above was followed to fabricate free standing poly(S-NBD2) microlens arrays except the PDMS replica was NOT trimmed, affording an about 1 mm thick poly(S-NBD2) backing to provide structural support to the microlens arrays. The scale of the reaction was also increased to accommodate the greater volume needed to be filled in the mold; for free standing films 1.05 g of elemental sulfur (70 wt/wt %) and 0.45 g of NBD2 (30 wt/wt %) was used.

### C. Experimental Section for Fresnel Fabrication

### Preparation of Polydimethylsiloxane (PDMS) Mold for Fabrication of Poly(S-r-NBD2) Lens

To a 50 mL disposable plastic beaker were added the silicone elastomer base and silicone elastomer curing agent in a 10:1 (v/v) ratio. The prepared master being replicated and the plastic Petri dish in which the sample would be held were thoroughly rinsed with DI water and then absolute ethanol to clean the surface. The resin was thoroughly mixed and then poured into the 10 cm Petri dish containing the acrylic master. The sample was placed in a vacuum oven and pressure was reduced in order to fully remove any bubbles (1 hours). Once devoid of bubbles the samples were moved to a heated oven held at room temperature and cured for 24 hours. After completely curing the molds were removed from the polystyrene Petri dish and the acrylic master carefully removed. Then, the replicas were trimmed to make a stamp for the lens on the substrate.

### Imprinting Lens Using PDMS Stamp.

A 50 mL 1 dram vial equipped with a magnetic stir bar was charged with elemental sulfur (S₈, masses detailed below) and placed in a 165 °C preheated oil bath. Once forming yellow colored molten sulfur, the comonomer NBD2 (masses detailed below) was added into the molten sulfur and resulting mixture was stirred at 165 °C until the mixture gave a viscous solution (7-10 minutes, depending on the compositions). The prepolymers were transferred using pre-heated glass pipette onto PDMS stamp, then, the pre-heated salt plate (NaCl) was placed on top of the filled stamp in a 165 °C oven. The polymer solution was then cured for 60 minutes, removed from the oven and cooled under a weight.
a. Preparation of poly(S₅₀-r-DIB₅₀) copolymer: The copolymerization was carried out by following the general method written above with S₈ (100 mg, 9.36 mmol based on S₈) and DIB (100 mg, 0.65 mL, 7.58 mmol).
b. Preparation of poly(S₇₀-r-DIB₃₀) copolymer: The copolymerization was carried out by following the general method written above with S₈ (140 m g, 9.36 mmol based on S₈) and DIB (60 mg, 0.65 mL, 7.58 mmol).

Para. 1. An article of manufacture comprising a reaction product of a mixture of elemental sulfur and a comonomer selected from one or more of vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers, wherein the reaction product is a polymer and the article of manufacture is a flat imaging optical lens or a micro-optic lens.

Para. 2. The article of Para. 1, wherein the elemental sulfur is S₈.

Para. 3. The article of Paras. 1 or 2, wherein the comonomer comprises a norbornene dimer.

Para. 4. The article of Paras. 1 or 2, wherein the comonomer comprises 1,3-diisopropenylbenzene.

Para. 5. The article of any one of Paras. 1-4, wherein the polymer exhibits a refractive index of from about 1.7 to about 2.2.

Para. 6. The article of any one of Paras. 1-5, wherein the polymer exhibits a glass transition temperature of from about 75 °C to about 100 °C.

Para. 7. The article of Para. 6, wherein the polymer exhibits a glass transition temperature of about 100 °C.

Para. 8. The article of any one of Paras. 1-7, wherein the article is substantially transparent to electromagnetic radiation having a wavelength of about 7 microns to about 14 microns, about 3 microns to about 5 microns, about 700 nm to about 1650 nm, or about 1310 nm to about 3000 nm.

Para. 9. The article of any one of Paras. 1-8, wherein the polymer is coated and cured as a thin film on a substrate.

Para. 10. The article of any one of Paras. 1-8, wherein the reaction product is shaped and cured using a mold.

Para. 11. The article of any one of Paras. 1-10, wherein the article is a Fresnel lens.

Para. 12. The article of any one of Paras. 1-10, wherein the article is a microlens array.

Para. 13. The article of any one of Paras. 1-10, wherein the article has a surface relief pattern that is modulated with spatial periodicity and has a feature size of from about 0.1 micron to about 100 microns or from about 0.1 mm to about 1 mm.

Para. 14. The article of any one of Paras. 1-10, wherein the article has a size and a dimension that are controlled by photolithographic methods to create masters on the dimensions of about 10 nm to about 1000 microns with respect to lens height and width.

Para. 15. An imaging device comprising the article of manufacture according to any one of Paras. 1-14.

Para. 16. The imaging device of Para. 15, wherein the imaging device is a long-wave infrared imaging device.

Para. 17. The imaging device of Para. 15 or 16, wherein the imaging device is a long-wave infrared thermal imaging device.

Para. 18. The imaging device of Para. 17, wherein the imaging device is a long-wave infrared thermal imaging device suitable for a temperature range of from about 40 °C to about 200 °C.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An article of manufacture comprising:
a reaction product of a mixture of elemental sulfur and a comonomer;
wherein:
the comonomer is selected from the group consisting of vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated monomers, or styrenic monomers, or a mixture of any two or more thereof; and
the reaction product is a polymer and the article of manufacture is a flat imaging optical lens or a micro-optic lens.

2. The article of claim 1, wherein the elemental sulfur is S₈.

3. The article of claim 1, wherein the comonomer comprises a norbornene dimer.

4. The article of claim 1, wherein the comonomer comprises 1,3-diisopropenylbenzene.

5. The article of claim 1, wherein the polymer exhibits a refractive index of from about 1.7 to about 2.2.

6. The article of claim 1, wherein the polymer exhibits a glass transition temperature of from about 75 °C to about 100 °C.

7. The article of claim 6, wherein the polymer exhibits a glass transition temperature of about 100 °C.

8. The article of claim 1, wherein the article is substantially transparent to electromagnetic radiation having a wavelength of about 7 microns to about 14 microns, about 3 microns to about 5 microns, about 700 nm to about 1650 nm, or about 1310 nm to about 3000 nm.

9. The article of claim 1, wherein the polymer is coated and cured as a thin film on a substrate.

10. The article of claim 1, wherein the reaction product is shaped and cured using a mold.

11. The article of claim 1, wherein the article is a Fresnel lens.

12. The article of claim 1, wherein the article is a microlens array.

13. The article of claim 1, wherein the article has a surface relief pattern that is modulated with spatial periodicity and has a feature size of from about 0.1 micron to about 100 microns or from about 0.1 mm to about 1 mm.

14. The article of claim 1, wherein the article has a size and a dimension that are controlled by photolithographic methods to create masters on the dimensions of about 10 nm to about 1000 microns with respect to lens height and width.

15. An imaging device comprising the article of manufacture according to claim 1.

16. The imaging device of claim 15, wherein the imaging device is a long-wave infrared imaging device.

17. The imaging device of claim 15, wherein the imaging device is a long-wave infrared thermal imaging device.

18. The imaging device of claim 17, wherein the imaging device is a long-wave infrared thermal imaging device suitable for a temperature range of from about 40 °C to about 200°C.
